(19) United States
(12) Patent Application Publication
(10) Pub. No.: US 2013/0030552 A1
(43) Pub. Date: Jan. 31, 2013

(54) OPTICALLY-PROJECTED USER INTERFACE FOR APPLIANCES

(71) Applicants: Bryan James Beckley, Louisville, KY (US); Daniel Vincent Brosnan, Louisville, KY (US); Brian Michael Schork, Louisville, KY (US); Steven David Paul, Louisville, KY (US); Richard DeVos, Goshen, KY (US); Christopher David Hunter, Louisville, KY (US); John P. Ouseph, Louisville, KY (US); Geoffrey Lee Ranard, Louisville, KY (US)

(72) Inventors: Bryan James Beckley, Louisville, KY (US); Daniel Vincent Brosnan, Louisville, KY (US); Brian Michael Schork, Louisville, KY (US); Steven David Paul, Louisville, KY (US); Richard DeVos, Goshen, KY (US); Christopher David Hunter, Louisville, KY (US); John P. Ouseph, Louisville, KY (US); Geoffrey Lee Ranard, Louisville, KY (US)

(21) Appl. No.: 13/192,866

(22) Filed: Jul. 28, 2011

(51) Int. Cl. G05B 15/02

(52) U.S. Cl. 700/17

(57) ABSTRACT

An apparatus comprises a front projection system operatively mounted as part of an appliance and configured to optically project a virtual user interface; an optics system operatively mounted as part of the appliance and configured to direct the virtual user interface optically projected by the front projection system onto a given surface; a user input system operatively mounted as part of the appliance and configured to receive one or more input selections made by a user in correspondence with one or more features that are part of the virtual user interface optically projected by the front projection system on the given surface via the optics system; and a controller operatively coupled to the front projection system and the user input system, and configured to control operation of one or more components of the appliance in response to the one or more input selections made by the user in correspondence with the one or more features that are part of the virtual user interface.

### BACKGROUND OF THE INVENTION

The subject matter disclosed herein relates to appliances, and more particularly to improved user interfaces on such appliances.

User interfaces (UIs) are well known components of a wide variety of appliances and other user-controllable devices and equipment. For example, household appliances such as refrigerators, washing machines, dryers, cooking ranges and dishwashers are known to have human-machine interface (HMI) panels that allow the user to select functions (e.g., start, stop, cycle/mode select, temperature settings, etc.) of the appliance by activating one or more buttons on the panel. The HMI panel in existing appliances is typically known to be a physical panel cut into or mounted on the face of the appliance. On the panel are one or more pushbuttons or switches that the user can physically contact (push) so as to activate or deactivate a function. Some such existing HMI panels are known to also include light emitting diode (LED) displays or liquid crystal displays (LCD).

However, once an HMI panel is physically mounted on an appliance, it is, for all intents and purposes, permanently fixed at that position. Also, when the HMI panel has actual physical pushbuttons or switches mounted thereon, there is no way to change the configuration of the panel or update the functions that the panel presents to the user without physically modifying the panel.

### BRIEF DESCRIPTION OF THE INVENTION

As described herein, the exemplary embodiments of the present invention overcome one or more disadvantages known in the art.

One aspect of the present invention relates to an apparatus comprising a front projection system operatively mounted as part of an appliance and configured to optically project a virtual user interface. The apparatus also comprises an optics system operatively mounted as part of the appliance and configured to direct the virtual user interface optically projected by the front projection system onto a given surface. Further, the apparatus comprises a user input system operatively mounted as part of the appliance and configured to receive one or more input selections made by a user in correspondence with one or more features that are part of the virtual user interface optically projected by the front projection system on the given surface via the optics system. Still further, the apparatus comprises a controller operatively coupled to the front projection system and the user input system, and configured to control operation of one or more components of the appliance in response to the one or more input selections made by the user in correspondence with the one or more features that are part of the virtual user interface.

In one or more embodiments, the surface of the appliance may be a selectively moveable surface that can be moved to a first position to allow the virtual user interface to be optically projected thereon and to a second position when not in use.

In one or more embodiments, the one or more features that are part of the virtual user interface may comprise one or more images representative of functions associated with the appliance. The virtual display may also comprise one or more multimedia objects such as, but not limited to, one or more videos, one or more web pages, etc., and/or other user desired information.

Advantageously, illustrative principles of the present invention provide for a virtual HMI panel that is not required to be permanently fixed on an appliance, and that is more easily reconfigurable (e.g., by software updates rather than by physically modifying a panel) and able to display multimedia and other information (related and unrelated to the use of the appliance).

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is a diagram of an optically-projected user interface system, in accordance with an embodiment of the invention;

FIGS. 2-5 are diagrams illustrating exemplary considerations for optically projecting a user interface onto an appliance surface or some other surface, in accordance with one or more embodiments of the invention;

FIGS. 6 and 7 are respective side and front views of a refrigerator appliance with an optically-projected user interface system, in accordance with an embodiment of the invention;

FIGS. 8 and 9 are respective side and front views of a refrigerator appliance with an optically-projected user interface system, in accordance with another embodiment of the invention;

FIGS. 10 and 11 are respective side and top down views of a refrigerator appliance with an optically-projected user interface system and sliding panel, in accordance with yet another embodiment of the invention;

FIGS. 12 and 13 are respective views of a refrigerator appliance with an optically-projected user interface system and flip panel in stored and opened positions, in accordance with a further embodiment of the invention;

FIGS. 14 and 15 are respective views of a cooking range appliance with an optically-projected user interface system and flip panel in stored and opened positions, in accordance with an embodiment of the invention;

FIG. 16 is a view of a cooking range appliance with an optically-projected user interface system, in accordance with another embodiment of the invention; and

FIG. 17 is a view of a dishwasher appliance with an optically-projected user interface system, in accordance with an embodiment of the invention.

### DETAILED DESCRIPTION OF THE EXEMPLARY EMBODIMENTS OF THE INVENTION

One or more of the embodiments of the invention will be described below in the context of an appliance such as a household appliance. However, it is to be understood that principles of the invention are not intended to be limited to use in household appliances. Rather, principles of the invention may be applied to and deployed in any other suitable environment in which it would be desirable to improve user interface efficiency and accessibility.

As illustratively used herein, the term “appliance” is intended to refer to a device or equipment designed to perform one or more specific functions, particularly but not limited to equipment for consumer use, e.g., a refrigerator, a cooking range, a laundry washer, a laundry dryer, a dishwasher, a microwave oven, etc. This may include but is not limited to equipment that is useable in household or commercial environments. Also, it is to be appreciated that the term “appliance” may include a water heater, an energy management device that interfaces to another appliance, or a standalone energy management device.

As illustratively used herein, the term “virtual” is intended to refer to “non-physical,” i.e., a virtual user interface is a non-physical user interface, or one that is realized via one or more optical projections (e.g., images and/or objects) presented on one or more surfaces.

As illustratively used herein, the phrase “user interface” is intended to refer to an area where interaction between a human and a machine occurs including but not limited to a user viewing or listening to some form of information presented by the machine and/or the user inputting one or more selections or commands to the machine. In the case of the appliance embodiments described herein, the machine is the appliance and the human is the user or consumer, and interaction between the user and the appliance is via a virtual user interface.

Illustrative principles of the invention provide for generation and presentation of a virtual user interface in an appliance. The virtual user interface is optically projected on a surface, such as a surface of an appliance or some other surface, and allows a user to control and select features of the appliance using the virtual user interface in conjunction with a user input system, as will be explained in detail below. In this manner, the physical HMI panel on an appliance can be supplemented or completely replaced with the virtual user interface. In the latter case, by eliminating the physical HMI panel used in existing appliances, such as a refrigerator, the panel cut-out that must be manufactured into the appliance is eliminated. Particularly in the case of a refrigerator where the HMI panel is typically on the refrigerator door and requires a portion of the refrigerator door and corresponding insulation to be cut out to accommodate the HMI panel, use of the virtual user interface allows for the refrigerator door to remain intact and thus free of cut-outs and loss of insulation. In this way, the energy efficiency of the appliance is greatly improved.

Furthermore, since the virtual user interface can be reconfigured simply by modifying or updating one or more computer programs (software or firmware) that are stored in the appliance and used to generate the virtual user interface and any features associated therewith, changes to the user interface can be made before, during and after installation of an appliance. That is, features on the user interface can be added, modified and/or deleted simply by changing the images and multimedia objects optically projected by the user interface system. Also, based on the use of a projection system that is capable of projecting multimedia objects, the virtual user interface may include the displaying of videos, web pages, television or other broadcast sources, and any information desired by a user (e.g., recipes, instruction manuals, manufacturer contact information, etc.).

Still further, due to the optical nature of the virtual user interface, the size and shape of the virtual user interface can be advantageously adjusted to accommodate any surface area size or shape upon which it is desired to display the interface. Also, sizes and shapes of individual features on the virtual user interface can be adjusted.

A description of one illustrative embodiment of an optically-projected user interface system is first given below, followed by several illustrative embodiments depicting different appliance implementations of such an advantageous user interface system. It is to be understood that while the figures below illustrate implementations in a few types of appliances, principles of the invention may be implemented in many other types of appliances not expressly illustrated.

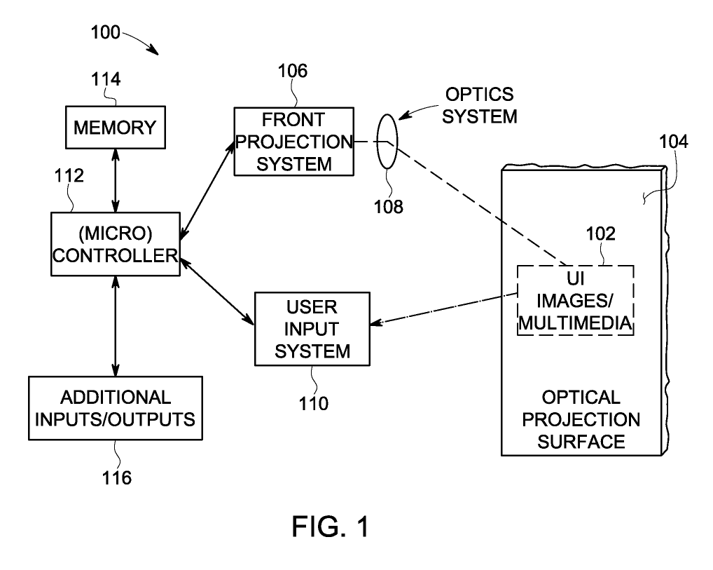

FIG. 1 is a diagram of an optically-projected user interface system 100, in accordance with an embodiment of the invention. As shown, one or more images and/or one or more multimedia objects 102 are optically projected and displayed on a surface 104. These images/objects comprise the virtual user interface (thus, 102 may be used herein below to refer to the images/objects or the virtual user interface as whole).

As explained herein, the surface 104 may be a surface of the appliance (e.g., a door or other front surface or a top or side surface) or a surface that is not part of the appliance (e.g., a counter top, a floor or a wall in proximity to the appliance). The surface may be made of one or more of a metal material (e.g., steel), a glass material, a plastic material, or a paper material. There is no limitation on the type of material of which the surface can be composed so long as it will accommodate the projection of the virtual user interface thereon.

As shown, the user interface system 100 also comprises a front projection system 106, an optics system 108, a user input system 110, a micro controller 112, memory 114 and one or more additional input sources and output destinations 116. It is to be noted that the types of connections between components shown in FIG. 1 are differentiated by the type of line shown, i.e., an electrical connection is shown as a solid line, an optical-projected connection is shown by a dashed line, and a physical connection is shown by a dashed-dotted line. However, principles of the invention are not limited to any particular connection types.

It is understood that a “front projection system” is intended to refer to an image/multimedia projector that projects an image/multimedia object on the front surface of the area upon which the image/multimedia object is intended to be presented. This is in contrast to a “rear projection system” that projects on a rear surface of the area upon which an image is intended to be presented, i.e., the projector is behind the projection surface and projects the image through the surface—which must of course be transparent or at least translucent.

It is realized that the use of a front projection system in an appliance implementation, such as a refrigerator, where the virtual user interface is to be projected on the front door (surface) of the appliance, is advantageous in that it does not require the projector to be mounted behind the projection surface in the refrigerator door as would be the case for a rear projection system. Thus, the insulation in the door would not be compromised since no mounting/cut-out area would be required to be made in the door of the appliance.

It is to be appreciated that principles of the invention are not limited to any particular front projection system. However, it is realized that certain advantages come from the projector being compact in size and energy usage. For these reasons, it is preferred to utilize a so-called “pico projector” as the front projection system. As is known, a pico projector includes miniaturized hardware that can accept instructions from a controller to generate and project one or more images and/or one or more multimedia objects onto a nearby surface. The pico projector typically utilizes laser light sources that are driven by control signals (from a controller) wherein the laser light sources may have different colors and intensities. The pico projector combines the laser light sources and projects the image or object. Pico projectors are known to be implemented with one or more integrated circuits.

While principles of the invention are not limited to any particular front projection system or pico projector, one or more models commercially available may be used. By way of example only, a Microvision (Redmond, Wash.) ShowWX+™, model BX10, pico projector could be employed. It is also understood however that, given specifications for colors, intensities, and proportions of the images/objects to be optically projected, any suitable pico projector could be used and/or customized for any particular implementation in a straightforward manner.

It is realized, however, that with the use of a front projection system and the topological configurations (and restrictions) of various appliances in which the front projection system may be used, it is preferable to utilize an optics system in conjunction with the pico projector that directs and focuses the projected images/objects onto the surface so that they are clear, accurate and readily viewable. This is the function of optics system 108 mounted in front of the optical output of front projection system 106. Optics system 108 may comprise one or more lens and/or one or more mirrors that provide the desirable directing and focusing of the image/object projected by the front projection system 106 so that it is properly presented on the surface 104.

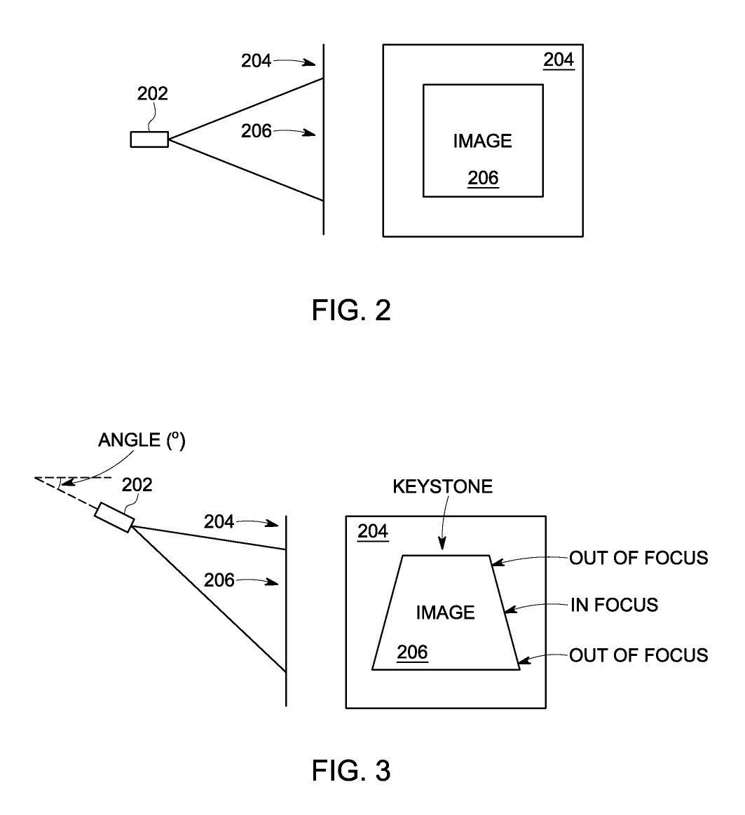

FIGS. 2-5 illustrate exemplary considerations for the desirability to include an optics system for use with the front projection system. As shown in FIG. 2, when the front projector 202 is placed perpendicular to and directly in front of the projection surface 204, the image 206 presented thereon is undistorted and clear, i.e., in focus. However, as shown in FIG. 3, when the projector 202 is not perpendicular to the projection surface 204, i.e., at some angle other than 90 degrees, the image 206 is distorted as shown. The distortion is called a “keystone effect” whereby the upper and lower parts of the image are out of focus, which is undesirable.

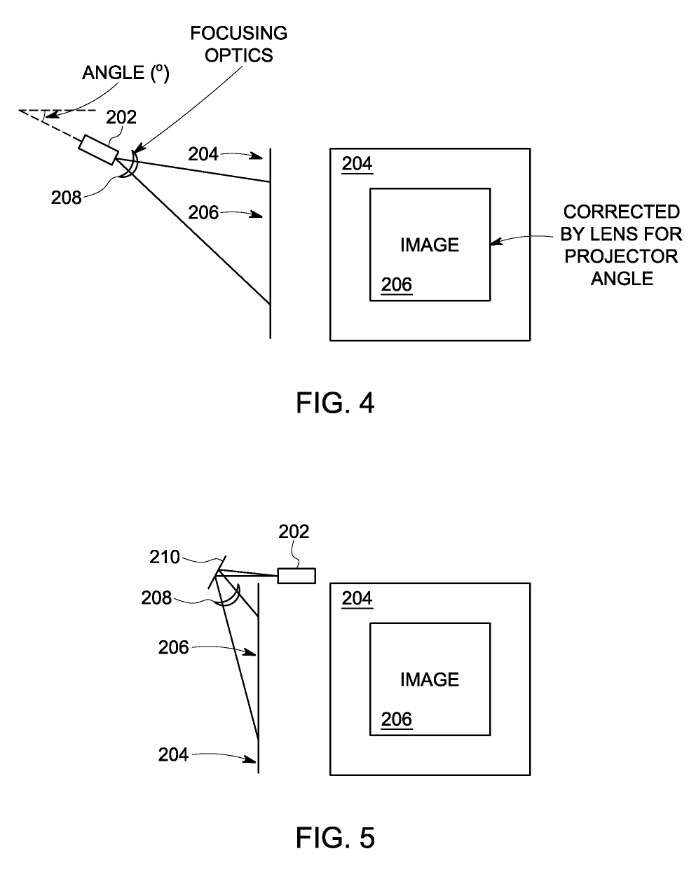

Advantageously, with the addition of focusing optics 208 (i.e., one or more lens) as shown in FIG. 4, the image 206 is correctly displayed (in focus) on the surface 204. That is, the distortion effect is compensated for by the one or more lenses. It is to be appreciated that one of ordinary skill in the art will realize what type of focusing lens are desirable to correct a focus issue given the angle of projection, light source type, surface to be displayed upon, etc.

Lastly, FIG. 5 shows an example of an addition of a reflecting mirror or lens 210 that may be used when the projector 202 is facing the same or a similar direction as the surface 204. The image projected by the projector 202 is directed by mirror 210 (mounted at a predetermined angle) toward the surface 204, and then passes through focusing lens 208 where the focus is corrected based on the angle of projection coming off of the mirror 210. In this manner, image 206 is presented correctly on the surface 204.

Thus, returning to FIG. 1, it is to be understood that optics system 108 represents any focusing lens (e.g., 208 in FIGS. 2-5) and reflecting mirrors (e.g., 210 in FIGS. 2-5) desired or necessary to properly project the virtual user interface onto surface 104. Again, one ordinarily skilled in the art will readily understand how to specify the lens/mirror parameters and characteristics given such factors as projection angle, surface, and projector type of the given implementation.

As also shown in FIG. 1, the user interface system 100 comprises user input system 110. User input system 110 is an input system that allows the user to input one or more selections that correspond with one or more features that are part of the virtual user interface 102 optically projected by the front projection system 106 on the surface 104. There are many different types of user input systems that may be employed including, but not limited to, a resistive input detection system, a capacitive input detection system, an optical-based input detection system, and a surface acoustic wave input detection system. By way of example only, one or more of the following technologies can be used: a capacitive touch system from Freescale Semiconductor (Austin, Tex.) identified as MPR121QR2; a resistive touch system from Texas Instruments (Dallas, Tex.) identified as TSC2301IPAGRG4; Elo Touch™ or iTouch™ Surface Wave systems from Tyco Electronics (Berwyn, Pa.). Also, any suitable optical recognition system or a suitable standard camera input with image/video processing algorithms may be employed. It is to be understood that since the user interface according to the principles of the invention is virtual in nature, and thus has features (pushbuttons, icons, etc.) that are selectable, the input system serves to assist in detecting which feature the user selected.

By way of example only, in resistive or capacitive-based approaches, the area of the surface 104 upon which the virtual user interface (images/objects) 102 is being projected has a corresponding area of resistive or capacitive sensitivity respectively built therein.

In a resistive input detection system, the area of resistive sensitivity comprises at least two thin electrically conductive (metallic) layers separated by a narrow gap. When an object, such as a finger, pushes down on a point in a given area of the surface, the two metallic layers come into electrical contact with one another at that point. This causes a change in an electrical current, which is registered as a touch event.

In a capacitive input detection system, the area of capacitive sensitivity comprises an insulator such as glass coated with a transparent conductor such as indium tin oxide. Since the human body is also an electrical conductor, touching a given area of the surface causes a distortion of in an electrostatic field, which is measurable as a change in capacitance. This is registered as a touch event.

An optical-based input detection systems works by monitoring the area of the user interface with one or more cameras that record where the user touched the interface. Further, an infrared-based system can be used whereby a disturbance or break in an infrared light beam is detected as a touch event. In a surface acoustic wave input detection system, the user's finger absorbs a portion of the acoustic wave propagating across the surface of the given area, which is registered as a touch event.

It is to be understood that any other suitable input detection technology can be used by the user input system 110 to identify feature selections made by the user at the virtual user interface. Principles of the invention are not restricted to any particular input detection technology. In fact, combinations of known input detection technologies may be utilized.

Since features of the virtual user interface are geometrically mapped to the underlying surface area upon which the virtual user interface is projected, the input system 110 reports the touch events to micro controller 112, which can then identify which feature was intended to be selected via the touch event by looking up the features mapped to the detected locations.

As further shown in FIG. 1, micro controller 112 is operatively coupled to the front projection system 106 and the user input system 110. The micro controller 112, inter alia, controls operation of one or more components of the appliance in response to the one or more input selections made by the user in correspondence with the one or more features that are part of the virtual user interface 102. The micro controller also controls the content of the virtual user interface display projected by the front projection system 106 and varies the display in response to user input selections.

For example, when the micro controller 112 is a microprocessor or central processing unit (CPU), this control may be accomplished by the controller executing one or more computer programs (software or firmware) that are loaded from memory 114. It is understood that the computer programs are preloaded (stored) in the appliance (e.g., in memory 114) prior to installation of the appliance. Such computer programs can also be easily updated after installation by replacing older software/firmware with newer software/firmware. In this way, features can be added to, modified or deleted from a virtual user interface, or entirely new virtual interfaces can be loaded.

Furthermore, the computer programs executed by the micro controller 112 instruct it as to what images/objects the micro controller is to instruct the front projection system 106 to project. This decision is also based on the selections made by the user at the virtual user interface, and by any input sources 116 (e.g., Internet, television broadcast, appliance components and subsystems, etc.) connected to the micro controller. Still further, the micro controller 112 can instruct components and subsystems of the appliance what to do based on user selections at the virtual user interface.

By way of example only, assume that a virtual user interface according to an embodiment of the invention is projected on the front door of a refrigerator. Assume also that one feature on the virtual user interface is a temperature control icon for the fresh food compartment of the refrigerator. Thus, when the user selects the temperature control icon, perhaps to decrease the temperature, the user input system 110 detects the touch event and reports it to the micro controller 112. The micro controller 112 may then instruct the front projection system 106 to project another image 102 on the surface 104 that shows the current temperature of the fresh food compartment with an up arrow icon and a down arrow icon. The user then touches the down arrow icon, and the user input system, micro controller, and front projection system work in cooperation to update the view that the user sees, i.e., the user sees the temperature of the fresh food compartment drop to the desired level on the display.

In addition, the micro controller 112 also instructs the components or subsystems of the appliance (e.g., evaporator system) that control the temperature in the fresh food compartment to decrease the temperature to the desired level. It is to be understood that the above is just one simple example of the multitude of features and functions that can be displayed and controlled for any given appliance via a virtual user interface formed according to principles of the invention.

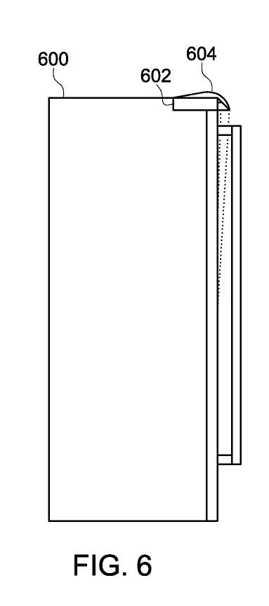

Descriptions of several illustrative embodiments depicting different appliance implementations of an optically-projected user interface system according to the invention will now be given in the context of FIGS. 6-17.

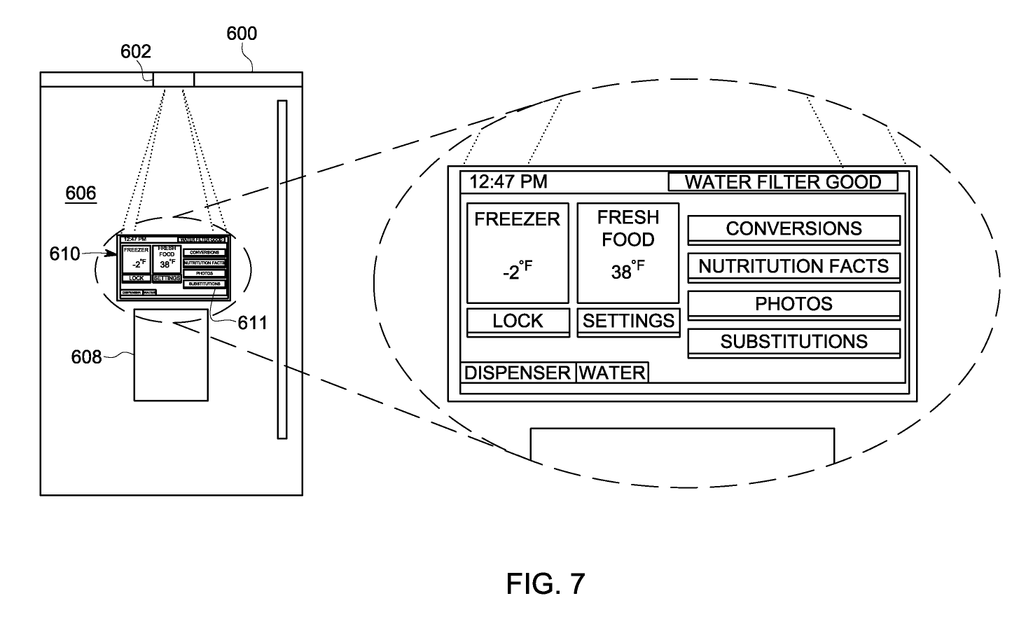

FIGS. 6 and 7 are respective side and front views of a refrigerator 600 with an optically-projected user interface system, in accordance with an embodiment of the invention. It is to be understood that the refrigerator 600 includes all of the components of the user interface system 100 of FIG. 1, although for ease of illustration, only certain of the components are shown.

As illustrated, front projection system 602 (106 in FIG. 1) is mounted at the top and front of the refrigerator. The optics system 604 (108 in FIG. 1) is mounted on top of and in front of the front projection system 602. As explained above, the optics system 604 directs and focuses the images/objects projected by the front projection system 602 on a surface of the refrigerator, in this case, the refrigerator door 606. In this exemplary embodiment, the virtual user interface 610 is displayed on the refrigerator door 606 just above the ice/water dispenser area 608. However, the virtual user interface 610 may be displayed on other parts of the refrigerator door or other surfaces. Note that the virtual user interface 610 includes one or more features 611 (e.g., icons, display areas, controls, etc.) that correspond to functions of the appliance.

Advantageously, the virtual user interface embodiment shown in the refrigerator in FIGS. 6 and 7 eliminates the hole in the refrigerator door created by having an LCD cut-out in the door when employing a traditional, physical HMI panel. This allows for additional foaming agent to be embedded into the door where the LCD would have been. The elimination of such a physical HMI panel also creates a cleaner, more aesthetically attractive front surface of the refrigerator.

Also note that the virtual user interface 610 can be displayed on curved surfaces rather than just flat surfaces. Any distortion that may otherwise be an issue due to the curved nature of the projection surface can be mitigated or eliminated by selection of appropriate lens in the optics system 604, as described above.

It is also assumed that the door surface 606 of the refrigerator is configured to have one or more user input detection technologies built therein or associated therewith (e.g., resistive, capacitive, optical, infrared, surface acoustic wave, etc.), as described above in detail. Further, by using surface acoustic wave technology where acoustic waves are propagated across the surface of the refrigerator door, the entire door can easily become part of the user input system (110 in FIG. 1).

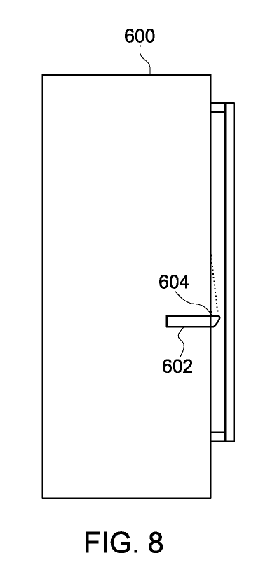

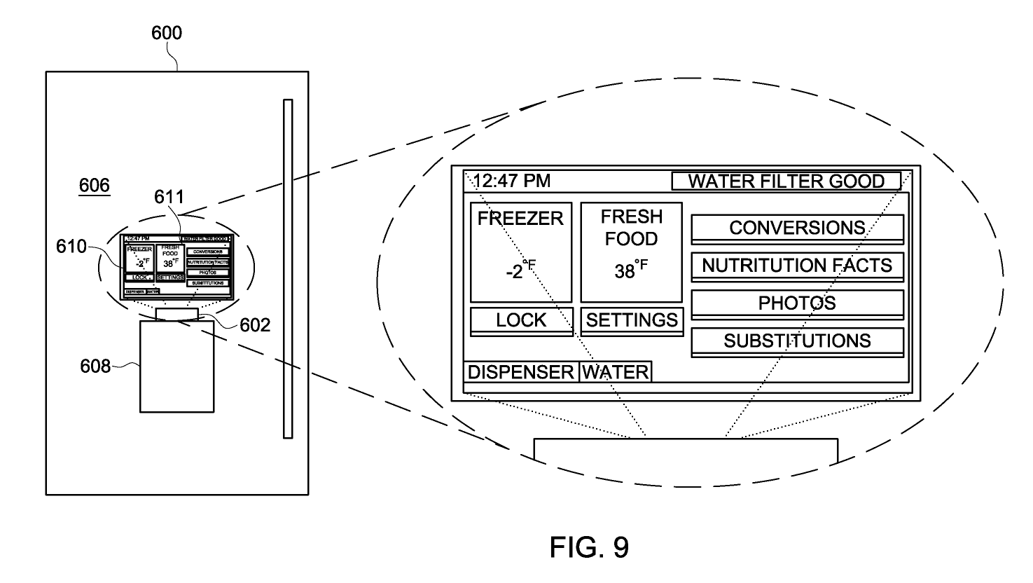

FIGS. 8 and 9 are respective side and front views of refrigerator 600 with an optically-projected user interface system, in accordance with another embodiment of the invention. In this embodiment, the front projection system 602 is mounted in or above the ice/water dispenser area 608, and the optics system 604 directs and focuses the virtual use interface 610 on the door 606 above the dispenser area 608.

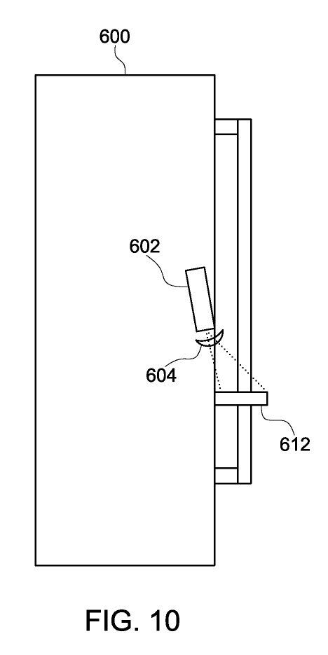

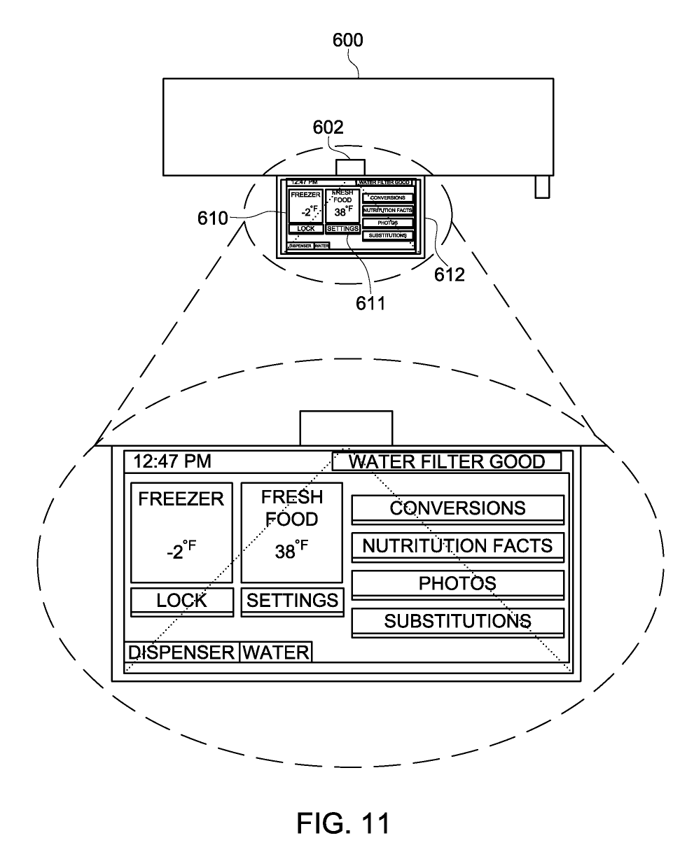

FIGS. 10 and 11 are respective side and top down views of refrigerator 600 with an optically-projected user interface system and sliding panel, in accordance with yet another embodiment of the invention. In this embodiment, the front projection system 602 is mounted in the refrigerator door 606 and is oriented so that the virtual user interface 610 is projected toward a selectively moveable panel 612 that is in or below the ice/water dispenser area 608. The front projection system 602 could also be mounted in the top of the dispenser area 608. In the embodiment in FIGS. 10 and 11, the panel 612 is selectively slid out by the user such that the virtual user interface 610 can be displayed thereon. The panel is configured to have user input detection technology as described above. The virtual user interface 610 displayed on the panel 612 can display, in addition to features described above, a proper location for the user to place a cup or glass to dispense ice or water. The projector could also provide different color lighting for the dispenser area. Projected light from the projection system could also be used to determine the fill level of a cup placed in the dispenser area.

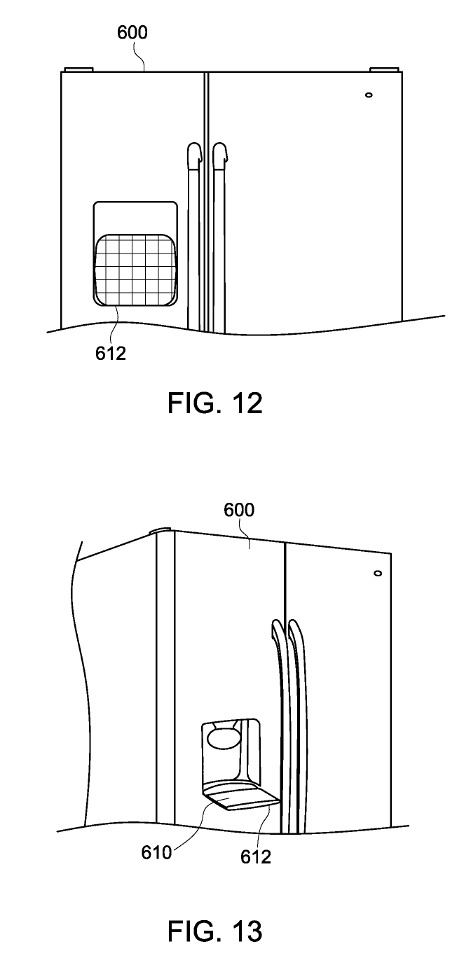

FIGS. 12 and 13 are respective views of refrigerator 600 with an optically-projected user interface system and flip panel in stored and opened positions, in accordance with a further embodiment of the invention. That is, the embodiment shown in FIGS. 12 and 13 is similar to the embodiment shown in FIGS. 10 and 11, except that the panel 612 upon which the virtual user interface 610 is to be displayed is a flip up (FIG. 12) and flip down (FIG. 13) panel.

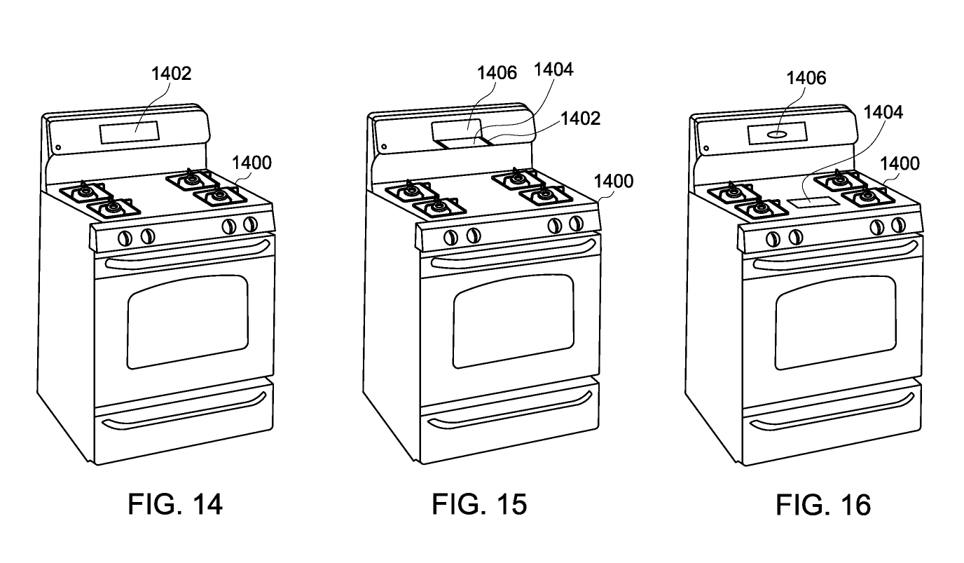

FIGS. 14 and 15 are respective views of a cooking range appliance with an optically-projected user interface system and flip panel in stored and opened positions, in accordance with an embodiment of the invention. Similar to the refrigerator appliances described above, a cooking range 1400 can have an optically-projected user interface system 100 (FIG. 1) implemented therein. As shown, a flip panel 1402 (in stored position in FIG. 14) is flipped down so that a virtual user interface 1404 can be projected thereon (FIG. 15). It is understood that the front projection system and optics system is located in the area denoted as 1406 in FIG. 15, i.e., the backsplash panel.

Advantages similar to those realized in the refrigerator implementations are realized in the embodiment of FIGS. 14 and 15 (e.g., eliminate HMI panel cut-outs, energy efficiency, allow for display on curved and other non-flat surfaces, reduction in size of HMI panel since size of virtual user interface can be selectively adjusted, etc.). In addition, the flip panel could be used as a temporary storage shelf for salt, pepper and spices (in cooking range implementation) or other items in other appliance implementations. Also, a micro switch (not expressly shown) could be employed to turn on the virtual user interface when the panel is flipped down. Alternatively, an optical detector (not expressly shown) could be used to automatically open the panel.

FIG. 16 is a view of a cooking range 1400 with an optically-projected user interface system, in accordance with another embodiment of the invention. In this embodiment, the front projection system and optics system (depicted in area 1406) project the virtual user interface 1404 onto the cook top of the range, in between the burners. One additional advantage in this embodiment is that the virtual user interface 1404 is displayed closer to the user so he/she does not have to reach over the appliance to control the appliance.

It is to be appreciated that since a cooking range and laundry (washer and dryer) appliances have similar structural configurations and topologies, an optically-projected user interface system of the invention could be implemented in laundry appliances in the same or a similar manner as shown in FIGS. 14-16. Further, other types of cooking appliances, such as microwave ovens may incorporate an optically-projected user interface system of the invention.

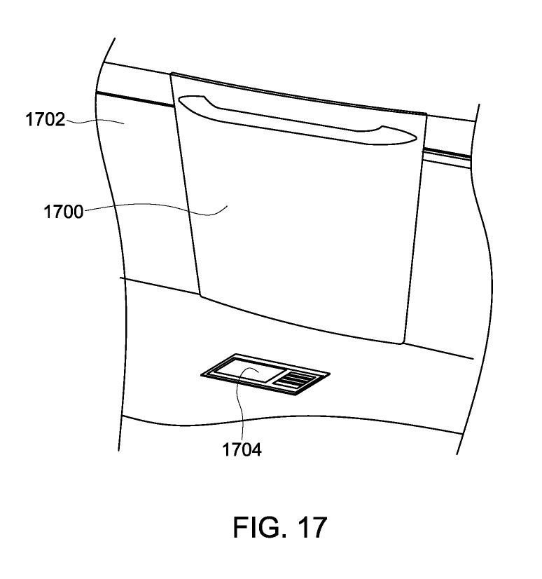

Lastly, FIG. 17 is a view of a dishwasher appliance with an optically-projected user interface system, in accordance with an embodiment of the invention. In this embodiment, dishwasher 1700 can have an optically-projected user interface system 100 (FIG. 1) implemented therein (with projector and optics in handle 1702 as shown, or in upper part of dishwasher front). The virtual user interface 1704 can be projected on the surface of the dishwasher or on the floor in front of the dishwasher. If on the floor in front of the dishwasher, an optical-based user input system may be used to detect touch events. This embodiment allows for all high voltage controls to be removed from the front panel of the dishwasher. Also, the user is able to select features on the virtual user interface 1704 via his/her feet.

It is to be appreciated that the one or more features that are included on a virtual user interface (and thus the corresponding virtual icons, virtual buttons, etc.) depend on the functions of the appliance in which the optically-projected user interface system of the invention is implemented. By way of example, and not intended to be an exhaustive list, below are some examples of the features/functions that may be incorporated into a virtual user interface in an appliance implementation: freezer/fresh food temperature control, diagnostics, show room mode control, display of weather information, display of pictures/photos, display of maintenance manuals, display of manufacturer contact information, display of multimedia objects, demand management controls, display of precise fill information, display of Internet content, display of time and date, oven/surface temperature controls, display of cooking applications, and wash/dry settings and controls. Of course, those of ordinary skill in the art will realize many other features that may be implemented in accordance with the inventive teachings disclosed herein.

Thus, while there have been shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus comprising:
a front projection system operatively mounted as part of an appliance and configured to optically project a virtual user interface;
an optics system operatively mounted as part of the appliance and configured to direct the virtual user interface optically projected by the front projection system onto a given surface;
a user input system operatively mounted as part of the appliance and configured to receive one or more input selections made by a user in correspondence with one or more features that are part of the virtual user interface optically projected by the front projection system on the given surface via the optics system; and
a controller operatively coupled to the front projection system and the user input system, and configured to control operation of one or more components of the appliance in response to the one or more input selections made by the user in correspondence with the one or more features that are part of the virtual user interface.

2. The apparatus of claim 1, wherein the given surface is a surface on the appliance.

3. The apparatus of claim 2, wherein the surface on the appliance is composed of at least one of a metal material, a glass material, and a plastic material.

4. The apparatus of claim 2, wherein the surface on the appliance is at least one of a flat surface and a curved surface.

5. The apparatus of claim 2, wherein the surface of the appliance is a selectively moveable surface that can be moved to a first position to allow the virtual user interface to be optically projected thereon and to a second position when not in use.

6. The apparatus of claim 1, wherein the given surface is a surface not on the appliance.

7. The apparatus of claim 1, wherein the appliance is one of a refrigerator appliance, a cooking appliance, a laundry appliance, and a dishwasher appliance.

8. The apparatus of claim 1, wherein the one or more features that are part of the virtual user interface correspond to one or more appliance controls that are selectable by the user.

9. The apparatus of claim 1, wherein the one or more features that are part of the virtual user interface comprise one or more multimedia objects.

10. The apparatus of claim 9, wherein the one or more multimedia objects comprise one or more videos.

11. The apparatus of claim 9, wherein the one or more multimedia objects comprise one or more webpages.

12. The apparatus of claim 1, wherein the one or more features that are part of the virtual user interface comprise user desired information.

13. The apparatus of claim 1, wherein the user input system comprises at least one of a resistive input detection system, a capacitive input detection system, an optical-based input detection system, infrared-based input detection system, and a surface acoustic wave input detection system.

14. The apparatus of claim 1, wherein the optics system comprises at least one of one or more lens and one or more mirrors for at least one of reflecting and focusing the virtual user interface optically projected by the front projection system on to the given surface.

15. An appliance comprising:
a first surface, wherein the first surface is accessible by a user of the appliance;
a front projection system operatively mounted as part of the appliance and configured to optically project a virtual user interface;
an optics system operatively mounted as part of the appliance and configured to direct the virtual user interface optically projected by the front projection system onto the first surface;
a user input system operatively mounted as part of the appliance and configured to receive one or more input selections made by the user in correspondence with one or more features that are part of the virtual user interface optically projected by the front projection system on the first surface via the optics system; and
a controller operatively coupled to the front projection system and the user input system, and configured to control operation of one or more components of the appliance in response to the one or more input selections made by the user in correspondence with the one or more features that are part of the virtual user interface.

16. The appliance of claim 15, wherein the first surface is an outer surface of the appliance.

17. The appliance of claim 16, wherein the outer surface is on a front portion of the appliance.

18. The appliance of claim 15, wherein the first surface is on a selectively moveable panel on the appliance.

19. The appliance of claim 18, wherein the panel is moved out from a stored position when it is desired to display the virtual user interface thereon, and moved back to the stored position when not in use.

20. The appliance of claim 15, wherein the appliance is one of a refrigerator appliance, a cooking appliance, a laundry appliance, and a dishwasher appliance.
